(19) United States
(12) Patent Application Publication
(10) Pub. No.: US 2025/0052031 A1
(43) Pub. Date: Feb. 13, 2025

(54) WELDED STRUCTURE AND WORK VEHICLE

(71) Applicant: KOMATSU LTD., Tokyo (JP)

(72) Inventor: Yukihide YOSHIHARA, Tokyo (JP)

(73) Assignee: KOMATSU LTD., Tokyo (JP)

(21) Appl. No.: 18/716,720

(22) PCT Filed: Nov. 2, 2022
(86) PCT No.: PCT/JP2022/041045

§ 371 Date: Jun. 5, 2024

(30) Foreign Application Priority Data
Dec. 21, 2021 (JP) 2021-207139

(51) Int. Cl. E02F 3/38

(52) U.S. Cl. CPC E02F 3/38

(57) ABSTRACT

A welded structure includes a first member which is a steel plate or a cast steel, a second member which is a steel plate or a cast steel disposed adjacent to the first member with a space therebetween, a first welded portion filling the space and joining the first member to the second member, and a backing material composed of a steel and disposed in contact with the first welded portion so as to close a first opening of the space, the backing material including a transformed region having a martensitic structure in the region in contact with the first welded portion. The steel constituting the backing material has a volume per unit mass greater at room temperature than at the Ms point.

### TECHNICAL FIELD

The present disclosure relates to a welded structure and a work vehicle.

The present application claims priority based on Japanese Patent Application No. 2021-207139 filed on Dec. 21, 2021, the entire contents of which are incorporated herein by reference.

### BACKGROUND ART

In a welded structure in which members (base materials) that are steel plates or cast steels are joined together by welding, fatigue fracture may occur starting from the area around the welded portion. In order to address this, it has been proposed to adopt a steel having a low Mₛ point as the steel constituting the welded portion and/or the steel constituting the base materials to thereby allow a compressive stress to remain in the region from which fatigue fracture may originate, thus increasing the fatigue strength of the welded structure (see, for example, Japanese Patent Application Laid-Open No. 2002-210557 (Patent Literature 1) and Japanese Patent Application Laid-Open No. 2005-288504 (Patent Literature 2)).

### CITATION LIST

### Patent Literature

Patent Literature 1: Japanese Patent Application Laid-Open No. 2002-210557
Patent Literature 2: Japanese Patent Application Laid-Open No. 2005-288504

### SUMMARY OF INVENTION

### Technical Problem

However, with the technique as described above, a large amount of high-cost steel will have to be used in a large welded structure as the steel constituting the welded portion and/or the steel constituting the base materials. This makes it difficult to apply the technique to a large welded structure. One of the objects of the present disclosure is to provide a welded structure having improved fatigue strength that can be applied even to a large welded structure, and a work vehicle including the welded structure.

### Solution to Problem

A welded structure of the present disclosure includes: a first member which is a steel plate or a cast steel; a second member which is a steel plate or a cast steel disposed adjacent to the first member with a space therebetween; a first welded portion filling the space and joining the first member to the second member; and a backing material composed of a steel and disposed in contact with the first welded portion so as to close a first opening of the space, the backing material including a transformed region having a martensitic structure in the region in contact with the first welded portion. The steel constituting the backing material has a volume per unit mass greater at room temperature than at the Mₛ point.

### Advantageous Effects of Invention

The above-described welded structure is capable of providing a welded structure having improved fatigue strength that can be applied even to a large welded structure.

### BRIEF DESCRIPTION OF DRAWINGS

FIG. 1 is a schematic perspective view showing the appearance of a hydraulic excavator in Embodiment 1.

FIG. 2 is a schematic plan view showing the appearance of a boom of the hydraulic excavator.

FIG. 3 is a schematic cross-sectional view of the boom along the line III-III in FIG. 2.

FIG. 4 is a schematic cross-sectional view of the boom in FIG. 3, showing an enlarged view of the area around a welded portion.

FIG. 5 is a schematic diagram illustrating the change in volume of a steel during cooling.

FIG. 6 is a schematic cross-sectional view of a welded structure in Embodiment 2, showing an enlarged view of the area around a welded portion.

FIG. 7 is a schematic cross-sectional view of a welded structure in Embodiment 3, showing an enlarged view of the area around a welded portion.

FIG. 8 is a schematic plan view showing the structure of a fatigue test specimen.

FIG. 9 is a schematic plan view of the test specimen in FIG. 8, shown from an opposite side in the thickness direction, with a backing material 31 removed therefrom.

FIG. 10 is a schematic cross-sectional view of the fatigue test specimen along the lines X-X in FIGS. 8 and 9.

FIG. 11 is a schematic cross-sectional view of a test specimen obtained by forming a second welded portion 22 and a third welded portion 23 prior to forming the welded portion 25 in the test specimen of FIGS. 8 to 10.

FIG. 12 is a diagram showing the distribution of residual stress in a region around the root of the test specimen in FIGS. 8 to 10.

FIG. 13 is a diagram showing the distribution of residual stress in regions around the toes of the second and third welded portions of the test specimen in FIG. 11.

FIG. 14 is a schematic diagram illustrating a method of conducting a fatigue test.

FIG. 15 is a diagram showing the fatigue test results for the test specimen of FIGS. 8 to 10.

FIG. 16 is a diagram showing the fatigue test results for the test specimen of FIG. 11.

### DESCRIPTION OF EMBODIMENTS

### [Outline of Embodiments]

A welded structure according to the present disclosure includes: a first member which is a steel plate or a cast steel; a second member which is a steel plate or a cast steel disposed adjacent to the first member with a space therebetween; a first welded portion filling the space and joining the first member to the second member; and a backing material composed of a steel and disposed in contact with the first welded portion so as to close a first opening of the space, the backing material including a transformed region having a martensitic structure in the region in contact with the first welded portion. The steel constituting the backing material has a volume per unit mass greater at room temperature than at the Mₛ point (temperature at which martensite begins to form in the structure).

During welding in the process of producing the welded structure according to the present disclosure, the first welded portion in the molten state and the backing material contact each other. Thus, the region of the backing material in the vicinity of a root, which is a region where the first welded portion and the backing material contact each other, is heated to a temperature not lower than the A₁ point. During the process of solidification of the first welded portion, the temperature of the first welded portion and the region of the backing material in the vicinity of the root drops rapidly. As a result, in the region of the backing material in the vicinity of the root, martensitic transformation occurs and a transformed region having a martensitic structure is formed. Here, the steel constituting the backing material of the welded structure of the present disclosure has a volume per unit mass greater at room temperature than at the Mₛ point. Thus, in the process where the welded portion is cooled to room temperature, the transformed region is cooled to the room temperature in the state of being expanded in the temperature range not higher than the Mₛ point. In this case, while the area in the vicinity of the root of the first welded portion in contact with the transformed region tries to expand along with the expansion of the transformed region, the first member and the second member restrain and inhibit such expansion. As a result, at room temperature, a compressive stress is applied to the regions in the first welded portion, the first member, and the second member in the vicinity of the root of the first welded portion, from which fatigue fracture may originate. This stress of compression causes the residual stress in the vicinity of the root of the first welded portion to be in a state of compression, or relaxes the state of tension. As a result, initiation and extension of cracks in the vicinity of the root of the first welded portion are inhibited, resulting in improved fatigue strength of the welded structure.

Further, for the purpose of improving the fatigue strength by way of the above-described mechanism, it is not necessary to use high-cost special materials for the materials constituting the first welded portion, the first member, and the second member; it is sufficient to adopt a steel having a volume per unit mass greater at room temperature than at the Mₛ point only for the steel constituting the backing material. Therefore, the configuration of the welded structure of the present disclosure is applicable, not only to a small welded structure, but also to a large welded structure. As described above, the welded structure of the present disclosure is capable of providing a welded structure having improved fatigue strength that can be applied even to a large welded structure. As used herein, the “room temperature” means 27° C. (300K).

The above-described welded structure may further include a second welded portion disposed in contact with the first member and the backing material and joining the first member to the backing material. With this, the second welded portion can be formed in advance to join the first member to the backing material before the formation of the first welded portion. This facilitates production of the welded structure. Further, since the second welded portion restrains the aforementioned expansion of the backing material during the formation of the first welded portion, a compressive stress is applied to the vicinity of the toe of the second welded portion. This stress of compression causes the residual stress in the vicinity of the toe of the second welded portion to be in a state of compression, or relaxes the state of tension. As a result, initiation and extension of cracks in the vicinity of the toe of the second welded portion, from which fatigue fracture may originate, are inhibited, resulting in improved fatigue strength of the welded structure.

The above-described welded structure may further include a third welded portion disposed in contact with the second member and the backing material and joining the second member to the backing material. With this, the third welded portion can be formed in advance to join the second member to the backing material before the formation of the first welded portion. This facilitates production of the welded structure. Further, similarly as with the vicinity of the toe of the second welded portion, initiation and extension of cracks in the vicinity of the toe of the third welded portion are inhibited, resulting in improved fatigue strength of the welded structure.

In the above-described welded structure, the first member and the second member may be steel plates or cast steels having a thickness of not less than 6 mm. The welded structure of the present disclosure can be applied effectively to such a large welded structure.

In the above-described welded structure, the steel constituting the backing material may have a yield stress greater than a yield stress of a material constituting the first welded portion. This facilitates applying a compressive stress to the vicinity of the root of the first welded portion.

A work vehicle of the present disclosure includes the above-described welded structure of the present disclosure. The work vehicle of the present disclosure is capable of providing a highly reliable work vehicle because it includes the welded structure having improved fatigue strength that can be applied even to a large welded structure.

In the above-described work vehicle, the welded structure of the present disclosure may be included in a work implement of the work vehicle. The welded structure of the present disclosure is suitable for a member constituting the work implement of the work vehicle.

The above-described work vehicle may be an excavator. The work vehicle of the present disclosure is suitably applicable to an excavator such as a hydraulic excavator, an electric excavator, or the like.

### SPECIFIC EMBODIMENTS

Specific embodiments of the work vehicle and the welded structure of the present disclosure will be described below with reference to the drawings. In the drawings referenced below, the same or corresponding portions are denoted by the same reference numerals and the description thereof will not be repeated.

### Embodiment 1

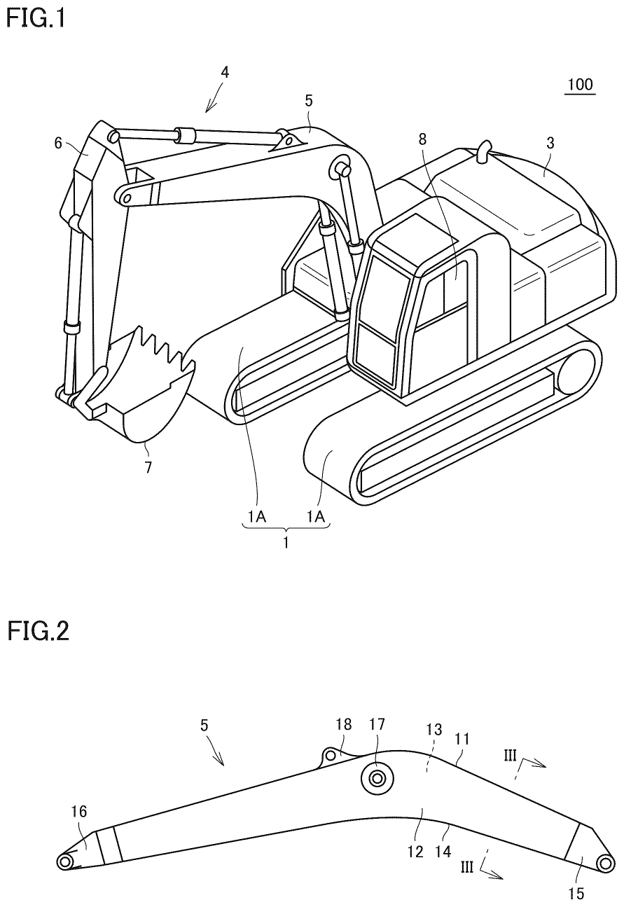

A hydraulic excavator and a boom of the hydraulic excavator, which are examples of the work vehicle and the welded structure according to the present disclosure, will first be described with reference to FIGS. 1 to 5. FIG. 1 is a schematic perspective view showing the appearance of the hydraulic excavator in Embodiment 1. Referring to FIG. 1, the hydraulic excavator 100 includes a travel unit 1, a revolving unit 3, and a work implement 4. The main body of the hydraulic excavator includes the travel unit 1 and the revolving unit 3. The travel unit 1 includes a pair of tracks 1A. The revolving unit 3 is attached to the travel unit 1 via a revolving mechanism at the top portion of the travel unit 1. The revolving unit 3 includes a cab 8.

The work implement 4 is supported operably in the vertical direction on the revolving unit 3 and can perform work such as excavating sand and other materials. The work implement 4 includes a boom 5, an arm 6, and a bucket 7. The boom 5 has its base portion connected to the revolving unit 3. The arm 6 is connected to a distal end of the boom 5. The bucket 7 is connected to a distal end of the arm 6. The boom 5, the arm 6, and the bucket 7 are each driven by a hydraulic cylinder to enable the desired operation of the work implement 4.

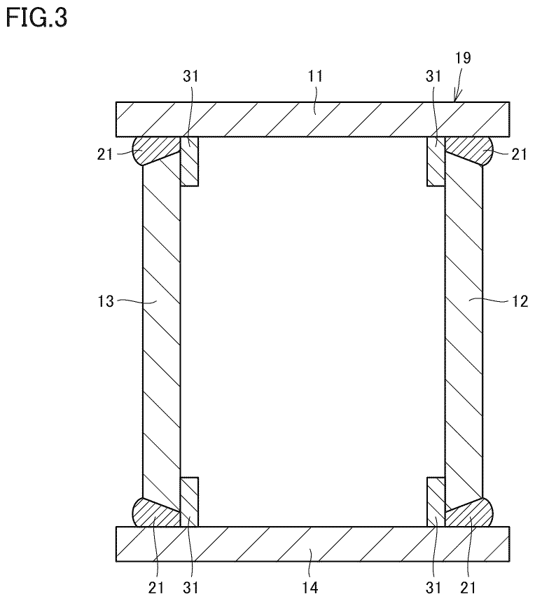

FIG. 2 is a schematic plan view showing the appearance of the boom of the hydraulic excavator. FIG. 3 is a schematic cross-sectional view of the boom along the line III-III in FIG. 2. Referring to FIGS. 2 and 3, the boom 5 includes an upper plate 11, a left side plate 12, a right side plate 13, and a lower plate 14. As shown in FIG. 3, the left side plate 12 and the right side plate 13 have upper ends joined to the upper plate 11 via welded portions 21 and lower ends joined to the lower plate 14 via welded portions 21. The right side plate 13 is spaced apart from and opposite to the left side plate 12. The left side plate 12 and the right side plate 13 are arranged approximately parallel to each other. The lower plate 14 is spaced apart from and opposite to the upper plate 11. The upper plate 11 and the lower plate 14 are arranged approximately parallel to each other. The upper plate 11, the left side plate 12, the right side plate 13, and the lower plate 14 are joined together to form a box-shaped structural body 19. The box-shaped structural body 19 is a welded structure.

The upper plate 11, the left side plate 12, the right side plate 13, and the lower plate 14 each have an elongated plate shape. The upper plate 11, the left side plate 12, the right side plate 13, and the lower plate 14 are, for example, steel plates having a thickness of 6 mm or more and 20 mm or less. The box-shaped structural body 19 formed with the upper plate 11, the left side plate 12, the right side plate 13, and the lower plate 14 is a long structural body extending in the longitudinal direction of the boom 5 (direction perpendicular to the paper plane of FIG. 3).

Referring to FIG. 2, the box-shaped structural body 19 has a first end in the longitudinal direction to which a boom foot bracket 15 is joined. The box-shaped structural body 19 has a second end in the longitudinal direction (opposite to the first end in the longitudinal direction) to which an arm mounting bracket 16 is joined. The boom foot bracket 15 and the arm mounting bracket 16 are joined to each of the upper plate 11, the left side plate 12, the right side plate 13, and the lower plate 14 at the longitudinal ends of the box-shaped structural body 19. The boom foot bracket 15 constitutes a rear end of the boom 5. The arm mounting bracket 16 constitutes a front end of the boom 5. The boom foot bracket 15 is coupled to the revolving unit 3 with a pin. The arm 6 is coupled to the arm mounting bracket 16 with a pin.

In the present embodiment, the direction in which the upper plate 11 and the lower plate 14 are aligned (vertical direction of FIG. 3) is referred to as a vertical direction. The direction in which the left side plate 12 and the right side plate 13 are aligned (left-right direction of FIG. 3) is referred to as a left-right direction. The direction in which the boom 5 extends, or the longitudinal direction of the box-shaped structural body 19 (direction perpendicular to the paper plane of FIG. 3) is referred to as a front-rear direction. In the front-rear direction, the side on which the boom 5 is connected to the revolving unit 3 is the rear direction, and the side on which the arm 6 is connected to the boom 5 is the front direction.

At an approximately central portion in the front-rear direction of the left side plate 12 and the right side plate 13, a boom cylinder mounting portion 17 is provided. A boom cylinder that drives the boom 5 has its distal end connected to the boom cylinder mounting portion 17. On the upper surface side of the upper plate 11, at an approximately central portion in its front-rear direction, an arm cylinder mounting portion 18 is provided. An arm cylinder that drives the arm 6 has its proximal end connected to the arm cylinder mounting portion 18.

The upper plate 11, the left side plate 12, the right side plate 13, and the lower plate 14 may each be formed by a piece of steel plate or cast steel. Alternatively, a plurality of steel plates or cast steels may be joined together by welding or the like to form each of the upper plate 11, the left side plate 12, the right side plate 13, and the lower plate 14. For the material constituting the upper plate 11, the left side plate 12, the right side plate 13, and the lower plate 14, Japanese Industrial Standards (JIS) SS400, SM570, SC450, or the like, for example, can be adopted. A reinforcing member for increasing the strength of the boom 5 may be disposed in an inner space of the box-shaped structural body 19.

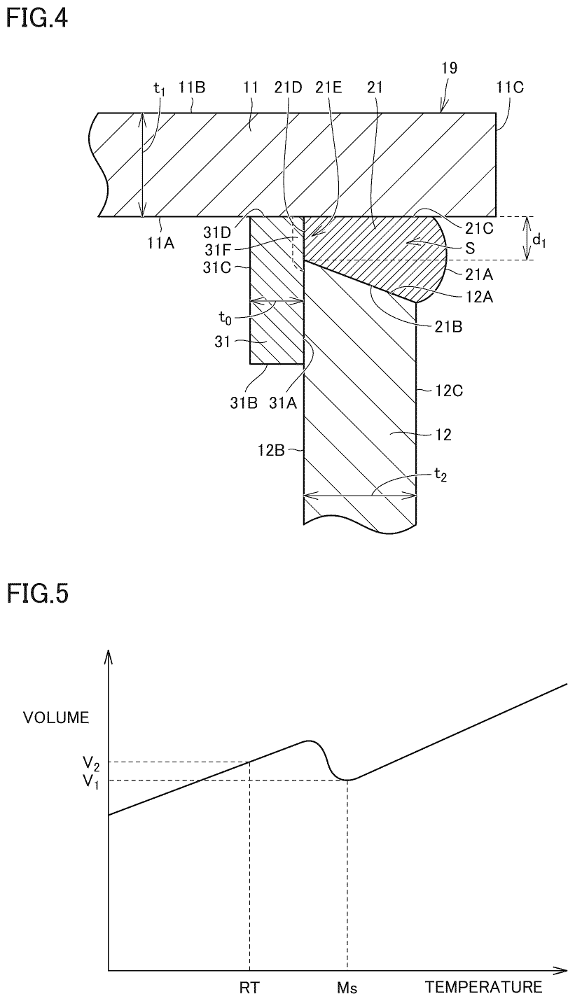

Referring to FIG. 3, the box-shaped structural body 19, which is the welded structure of the present embodiment, includes four welded portions 21. The four welded portions 21 and their surroundings have substantially the same structure. The structure of the welded portion 21 joining the upper plate 11 to the left side plate 12 and its surroundings will be described below with reference to FIG. 4.

Referring to FIG. 4, the box-shaped structural body 19, which is the welded structure of the present embodiment, includes the upper plate 11, which is a first member, the left side plate 12, which is a second member, the welded portion 21, and a backing material 31. The upper plate 11 and the left side plate 12 are composed of steel or cast steel. The upper plate 11 is a steel plate having a thickness t₁ of 6 mm or more and 20 mm or less. The left side plate 12 is a steel plate having a thickness t₂ of, for example, 6 mm or more and 20 mm or less. For the material constituting the upper plate 11 and the left side plate 12, SS400, SM570, or the like, for example, can be adopted.

The upper plate 11 has an inner surface 11A, an outer surface 11B, and an end surface 11C. The left side plate 12 has an inner surface 12B, an outer surface 12C, and an end surface 12A. The upper plate 11 and the left side plate 12 are arranged adjacent to each other such that the inner surface 11A and the end surface 12A face each other with a space S therebetween. The end surface 12A of the left side plate 12 is a tapered surface that has an increasing distance from the inner surface 11A of the upper plate 11 as it approaches the outer surface 12C. It should be noted that the end surface 12A of the left side plate 12 may be a straight surface instead of the tapered surface. In other words, the end surface 12A of the left side plate 12 constituting a groove may be tapered or straight.

The first welded portion 21 fills the space S. The first welded portion 21 joins the upper plate 11 to the left side plate 12. The first welded portion 21 is a region formed by welding. The first welded portion 21 is a portion formed as a result of solidification of a region melted during welding. The first welded portion 21 has an outer surface 21A, a first side surface 21C, a second side surface 21B, and a bottom surface 21D. The first welded portion 21 is in contact with the inner surface 11A of the upper plate 11 at the first side surface 21C. The first welded portion 21 is in contact with the end surface 12A of the left side plate 12 at the second side surface 21B. The first welded portion 21 is in contact with a first surface 31A of the backing material 31 at the bottom surface 21D. The first welded portion 21 has a root 21E, which is a region in contact with the backing material 31. A root gap d₁, which is a width of the root 21E, can be, for example, 4.0 mm or more and 10.0 mm or less.

The backing material 31 has the first surface 31A, a second surface 31B, a third surface 31C, and a fourth surface 31D. The backing material 31 has an elongated plate shape that extends along the longitudinal direction of the box-shaped structural body 19. The first surface 31A and the third surface 31C are arranged approximately parallel to each other at a distance in the thickness direction of the backing material 31. The backing material 31 may have a thickness t₀ of, for example, 4 mm or more and 12 mm or less. The backing material 31 is in contact with the inner surface 12B of the left side plate 12 and the bottom surface 21D of the first welded portion 21 at the first surface 31A. The backing material 31 is in contact with the inner surface 11A of the upper plate 11 at the fourth surface 31D. The backing material 31 is arranged to close an opening of the space S on the root 21E side (the side of the inner surfaces 11A and 12B of the upper plate 11 and the left side plate 12). The backing material 31 includes a transformed region 31F having a martensitic structure in the region in contact with the first welded portion 21. The proportion of the martensitic structure in the transformed region 31F is, for example, 50 vol % or more, and may be 80 vol % or more.

The backing material 31 is composed of a steel having a volume per unit mass greater at room temperature than at the Mₛ point. The Mₛ point of the steel constituting the backing material 31 can be, for example, 220° C. or higher and 400° C. or lower. The steel constituting the backing material 31 may be, for example, a steel that contains 0.03 mass % or more and 0.06 mass % or less C (carbon), 0.1 mass % or more and 0.3 mass % or less Si (silicon), 0.2 mass % or more and 0.4 mass % or less Mn (manganese), and 9.0 mass % or more and 13.0 mass % or less Ni (nickel), with the balance being Fe (iron) and unavoidable impurities. The steel constituting the backing material 31 may also be, for example, a steel that contains 0.02 mass % or more and 0.05 mass % or less C, 0.1 mass % or more and 0.3 mass % or less Si, 0.1 mass % or more and 0.3 mass % or less Mn, 7.0 mass % or more and 11.0 mass % or less Ni, and 10.0 mass % or more and 16.0 mass % or less Cr (chromium), with the balance being Fe and unavoidable impurities. The steel constituting the backing material 31 may also be, for example, a steel that contains 0.02 mass % or more and 0.05 mass % or less C, 0.3 mass % or more and 0.5 mass % or less Si, 3.0 mass % or more and 6.0 mass % or less Mn, and 0.0 mass % or more and 5.0 mass % or less Ni, with the balance being Fe and unavoidable impurities.

The outline of the method of forming the first welded portion 21 joining the upper plate 11 to the left side plate 12 will now be described with reference to FIGS. 4 and 5. FIG. 5 is a schematic diagram illustrating the change in volume of the steel constituting the backing material 31 during cooling. In FIG. 5, the horizontal axis corresponds to the temperature. In FIG. 5, the vertical axis corresponds to the volume per unit mass. Referring to FIG. 4, the upper plate 11 and the left side plate 12 are first arranged such that the inner surface 11A and the end surface 12A face each other. The backing material 31 is also arranged to contact the inner surfaces 11A and 12B of the upper plate 11 and the left side plate 12 and to close the space S. Thereafter, welding is performed using a welding wire (filler material) to form a first welded portion 21 in a molten state. At this time, the portions of the upper plate 11, the left side plate 12, and the backing material 31 that are in contact with the first welded portion 21 melt and become part of the first welded portion 21. In other words, the first welded portion 21 has a composition in which the components constituting the upper plate 11, the left side plate 12, and the backing material 31 are mixed with the components constituting the welding wire.

At this time, the first welded portion 21 in the molten state contacts the backing material 31. With this, the region of the backing material 31 in the vicinity of the root 21E is heated to a temperature not lower than the A₁ point (temperature at which the structure transforms from ferrite to austenite). During the process of solidification of the first welded portion 21, the temperature of the region of the backing material 31 in the vicinity of the root 21E decreases rapidly. As a result, as shown in FIG. 5, the temperature of the region of the backing material 31 in the vicinity of the root 21E becomes below the Mₛ point, which causes martensitic transformation to occur, resulting in the formation of the transformed region 31F having the martensitic structure. The volume per unit mass (hereinafter, also simply referred to as “volume”) of the transformed region 31F at the Mₛ point is V₁. The volume of the transformed region 31F increases with the martensitic transformation and then decreases by further cooling.

Here, the steel constituting the backing material 31 in the present embodiment has a volume per unit mass greater at room temperature (RT) than at the Mₛ point. Specifically, the volume of the transformed region 31F at room temperature is V₂. With the expansion of this transformed region 31F, a compressive stress is applied at room temperature to the regions of the first welded portion 21, the upper plate 11, and the left side plate 12 in the vicinity of the root 21E of the first welded portion 21, from which fatigue fracture may originate. This stress of compression causes the residual stress in the vicinity of the root 21E to be in a state of compression, or relaxes the state of tension. As a result, initiation and extension of cracks in the vicinity of the root 21E of the first welded portion 21 are inhibited, resulting in improved fatigue strength of the welded structure 19.

Further, in the present embodiment, it is not necessary to use high-cost special materials for the steels constituting the first welded portion 21, the upper plate 11, the left side plate 12, the right side plate 13, and the lower plate 14; it is sufficient to adopt a steel having a volume per unit mass greater at room temperature than at the Mₛ point only for the steel constituting the backing material 31. Accordingly, the box-shaped structural body 19 of the present embodiment is a welded structure having improved fatigue strength that can be applied even to a large welded structure. Further, the hydraulic excavator 100 as the work vehicle of the present embodiment is a highly reliable work vehicle with the inclusion of the box-shaped structural body 19 in the boom 5 of the work implement 4.

In the above embodiment, the steel constituting the backing material 31 may have a yield stress greater than the yield stress of the material constituting the first welded portion 21. This facilitates applying the compressive stress to the vicinity of the root 21E of the first welded portion 21.

### Embodiment 2

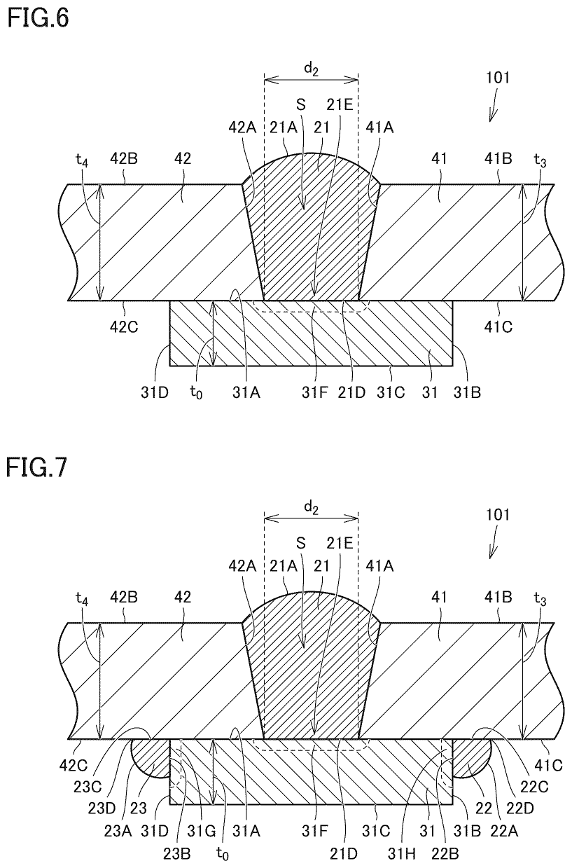

Another embodiment, Embodiment 2, will now be described with reference to FIG. 6. Referring to FIGS. 6 and 4, a welded structure 101 of Embodiment 2 basically has a similar structure and provides similar effects as the box-shaped structural body 19 as the welded structure of Embodiment 1. However, the welded structure 101 of Embodiment 2 differs from the case of Embodiment 1 in that a first member 41 and a second member 42, which are steel plates or cast steels, have their end surfaces joined to each other by welding.

Referring to FIG. 6, the welded structure 101 of the present embodiment includes the first member 41, the second member 42, a welded portion 21, and a backing material 31. The first member 41 and the second member 42 are composed of similar materials and have similar thicknesses t₃ and t₄ as the upper plate 11 and the left side plate 12 in Embodiment 1.

The first member 41 and the second member 42 have first surfaces 41C, 42C, second surfaces 41B, 42B, and end surfaces 41A, 42A. The end surfaces 41A and 42A of the first member 41 and the second member 42 are arranged adjacent to each other so as to face each other with a space S therebetween. The end surfaces 41A and 42A are tapered surfaces having their distance increasing as they approach the second surfaces 41B and 42B. It should be noted that the end surface of the first member 41 and the end surface of the second member 42 may be straight surfaces instead of tapered surfaces. That is, the end surfaces 41A and 42A constituting a groove may be straight surfaces instead of tapered surfaces.

The first welded portion 21 fills the space S. The first welded portion 21 joins the first member 41 to the second member 42. The first welded portion 21 is a region formed by welding. The first welded portion 21 is a portion formed as a result of solidification of a region melted during welding. The first welded portion 21 is in contact with a first surface 31A of the backing material 31 at a bottom surface 21D. The first welded portion 21 has a root 21E, which is a region in contact with the backing material 31. A root gap d₂, which is a width of the root 21E, can be, for example, 4.0 mm or more and 10.0 mm or less.

The backing material 31 is in contact with the first surfaces 41C and 42C of the first member 41 and the second member 42 and the bottom surface 21D of the first welded portion 21 at the first surface 31A. The backing material 31 is arranged to close an opening of the space S on the root 21E side (the side of the first surfaces 41C and 42C of the first member 41 and the second member 42). The backing material 31 includes a transformed region 31F having a martensitic structure in the region in contact with the first welded portion 21.

In the present embodiment as well, the backing material 31 is composed of a steel having a volume per unit mass greater at room temperature than at the Mₛ point, so that, as in the case of Embodiment 1, a compressive stress is applied at room temperature to the regions of the first welded portion 21, the first member 41, and the second member 42 in the vicinity of the root 21E of the first welded portion 21, from which fatigue fracture may originate. This stress of compression causes the residual stress in the vicinity of the root 21E to be in a state of compression, or relaxes the state of tension. With this, initiation and extension of cracks in the vicinity of the root 21E of the first welded portion 21 are inhibited, resulting in improved fatigue strength of the welded structure 101. As a result, the welded structure 101 of the present embodiment, similar to the box-shaped structural body 19 of Embodiment 1 above, is a welded structure having improved fatigue strength that can be applied even to a large welded structure.

### Embodiment 3

Yet another embodiment, Embodiment 3, will now be described with reference to FIG. 7. Referring to FIGS. 7 and 6, a welded structure 101 of Embodiment 3 basically has a similar structure and provides similar effects as the welded structure 101 of Embodiment 2. However, the welded structure 101 of Embodiment 3 differs from the case of Embodiment 2 in that it further includes a second welded portion 22 and a third welded portion 23.

Referring to FIG. 7, the second welded portion 22 includes an outer surface 22A, a first side surface 22B, and a second side surface 22C. The second welded portion 22 is in contact with the second surface 31B of the backing material 31 at the first side surface 22B. The second welded portion 22 is in contact with the first surface 41C of the first member 41 at the second side surface 22C. The second welded portion 22 joins the first member 41 to the backing material 31. With the formation of the second welded portion 22, a transformed region 31H is formed in the backing material 31 according to a similar mechanism as the transformed region 31F.

The third welded portion 23 includes an outer surface 23A, a first side surface 23B, and a second side surface 23C. The third welded portion 23 is in contact with the fourth surface 31D of the backing material 31 at the first side surface 23B. The third welded portion 23 is in contact with the first surface 42C of the second member 42 at the second side surface 23C. The third welded portion 23 joins the second member 42 to the backing material 31. With the formation of the third welded portion 23, a transformed region 31G is formed in the backing material 31 according to a similar mechanism as the transformed region 31F.

In the welded structure 101 of the present embodiment, the second welded portion 22 and the third welded portion 23 can be formed in advance to join the first member 41 and the second member 42 to the backing material 31 before the formation of the first welded portion 21. This facilitates production of the welded structure 101. Further, with the formation of the transformed regions 31H and 31G, a compressive stress can be applied to the regions of the second welded portion 22 and the third welded portion 23 in the vicinity of the transformed regions. This can suppress initiation and extension of cracks in the above regions of the second welded portion 22 and the third welded portion 23. Moreover, the second welded portion 22 and the third welded portion 23 restrain the expansion of the backing material 31 in the directions along the first surface 31A during the formation of the first welded portion 21. With this, a compressive stress is applied to the vicinity of toes 22D and 23D of the second welded portion 22 and the third welded portion 23. This stress of compression causes the residual stress in the vicinity of the toes 22D and 23D of the second welded portion and the third welded portion 23 to be in a state of compression, or relaxes the state of tension. As a result, initiation and extension of cracks in the vicinity of the toes 22D and 23D of the second welded portion and the third welded portion 23, from which fatigue fracture may originate, are inhibited, resulting in improved fatigue strength of the welded structure. While the case where both the second welded portion 22 and the third welded portion 23 are formed has been described in the present embodiment, only one of the second and third welded portions may be formed.

### EXAMPLES

Test specimens imitating the welded structure of the present disclosure were prepared to investigate the distribution of residual stress in the vicinity of the root, and the test specimens were also subjected to a fatigue test to confirm the fatigue strength. The experimental procedures were as follows.

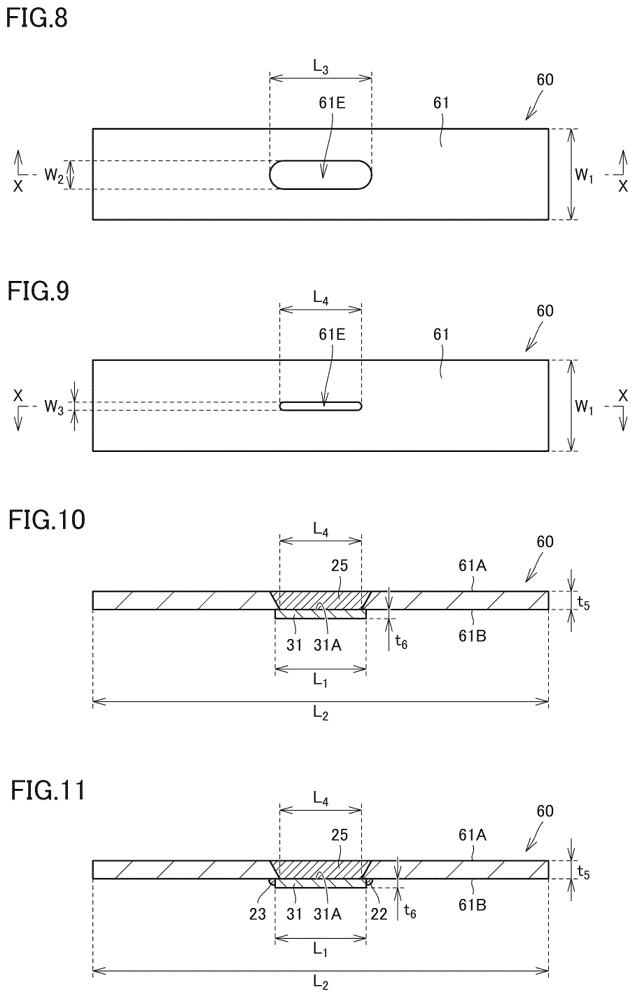

FIGS. 8 to 10 show the structure of a test specimen. Referring to FIGS. 8 to 10, the test specimen 60 includes a body portion 61, a backing material 31, and a welded portion 25. The body portion 61 has a plate shape with a width W₁ of 80 mm, a length L₂ of 400 mm, and a thickness t₅ of 16 mm. At a central portion in the longitudinal and width directions of the body portion 61, a through hole 61E is formed to penetrate in the thickness direction from a first main surface 61A to a second main surface 61B. The planar shape of the through hole 61E as seen from the first main surface 61A side is a rectangular shape having a length L₃ of 71 mm and a width W₂ of 15 mm, with arc-shaped corners. The inner wall surface of the through hole 61E is a tapered surface, with the cross section of the through hole 61E perpendicular to the thickness direction having an area that decreases as it approaches from the first main surface 61A to the second main surface 61B. The cross-sectional area of the through hole 61E is smallest at the second main surface 61B. The through hole 61E at the opening on the second main surface 61B side has a rectangular shape with a length La of 60 mm and a width W₃ of 4 mm, with arc-shaped corners. The material constituting the body portion is JIS SS400.

The backing material 31 is disposed to close the opening of the through hole 61E on the second main surface 61B side. The backing material 31 has a planar shape of a rectangular plate shape. With the body portion 61 and the backing material 31 arranged in the above-described manner, welding was performed to form a welded portion 25 so as to fill in the through hole 61E. As a result, the backing material 31 was fixed to the welded portion 25, with the welded portion 25 in contact with a first surface 31A of the backing material 31. For the material constituting the backing material 31, a steel containing 0.055 mass % C, 0.17 mass % Si, 0.25 mass % Mn, and 10.02 mass % Ni, with the balance being Fe and unavoidable impurities, was adopted. The backing material 31 has a plate shape with a length L₁ of 80 mm and a width W₄ (not shown) of 20 mm. The backing material 31 has a thickness to of 9 mm. The welding wire used for welding was JIS YGW11. A test specimen 60 was obtained according to the above-described procedure (Inventive Example). For comparison, a test specimen was also prepared using JIS SS400 as the material for the backing material 31 (Comparative Example). Furthermore, for each of Inventive and Comparative Examples, a test specimen having a second welded portion 22 and a third welded portion 23 formed before the formation of the welded portion 25, as shown in FIG. 11, was also prepared.

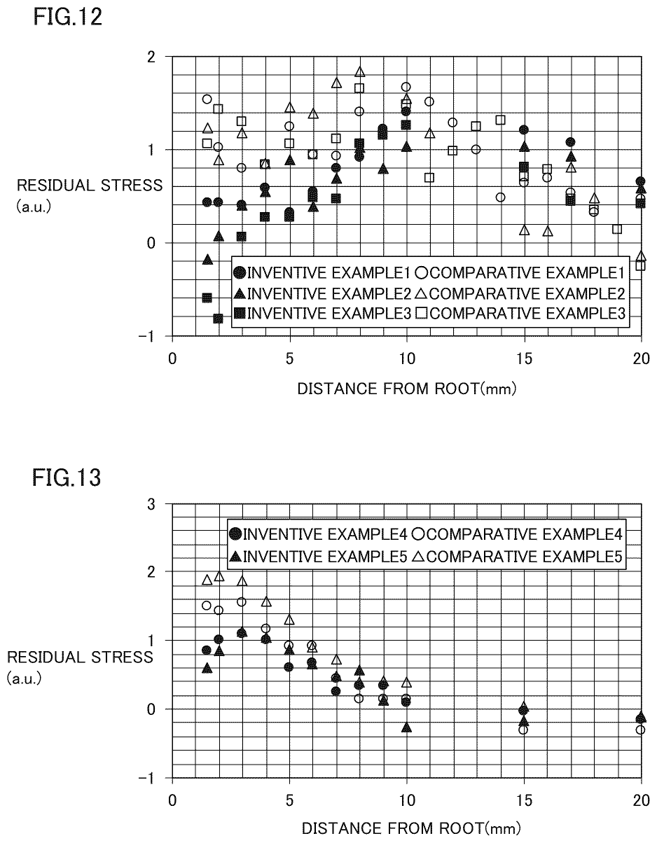

For the obtained test specimens of FIGS. 8 to 10, the distribution of residual stress in the body portion 61 in the vicinity of the interface between the welded portion 25 and the backing material 31, corresponding to the root, was measured. The residual stress was measured by X-ray diffraction. The measurement results are shown in FIG. 12. In FIG. 12, the horizontal axis corresponds to the distance from the interface between the welded portion 25 and the backing material 31 (the root). The vertical axis corresponds to the residual stress, wherein values are shown in arbitrary units, with values positive for tensile stress and negative for compressive stress. Measurements were performed on three test specimens for both Inventive and Comparative Examples (Inventive Examples 1 to 3 and Comparative Examples 1 to 3). The data points for Inventive Examples are shown as solid data points, and the data points for Comparative Examples are shown as hollow data points.

Referring to FIG. 12, it can be seen that in the test specimens corresponding to the examples of the present disclosure, the residual stress is in a state of compression, or in a relaxed state of tension, in the vicinity of the root (near the interface between the welded portion 25 and the backing material 31). This is considered to be the effect of the fact that the backing material 31 is made of a steel that has a volume per unit mass greater at room temperature than at the Mₛ point, as described above.

Further, for the test specimens of FIG. 11, the distribution of residual stress in the body portion 61 in the vicinity of the toes of the second welded portion 22 and the third welded portion 23 was measured. The residual stress was measured by X-ray diffraction. The measurement results are shown in FIG. 13. In FIG. 13, the horizontal axis corresponds to the distance from the toes of the second welded portion 22 and the third welded portion 23. The vertical axis corresponds to the residual stress, wherein values are shown in arbitrary units, with values positive for tensile stress and negative for compressive stress. Measurements were performed on two test specimens for both Inventive and Comparative Examples (Inventive Examples 4 and 5 and Comparative Examples 4 and 5). The data points for Inventive Examples are shown as solid data points, and the data points for Comparative Examples are shown as hollow data points.

Referring to FIG. 13, it can be seen that the test specimens corresponding to the examples of the present disclosure are in the state where the tensile stress is reduced in the vicinity of the toes of the second welded portion 22 and the third welded portion 23. This is considered to be the effect of the fact that the backing material 31 is made of a steel that has a volume per unit mass greater at room temperature than at the Mₛ point, as described above.

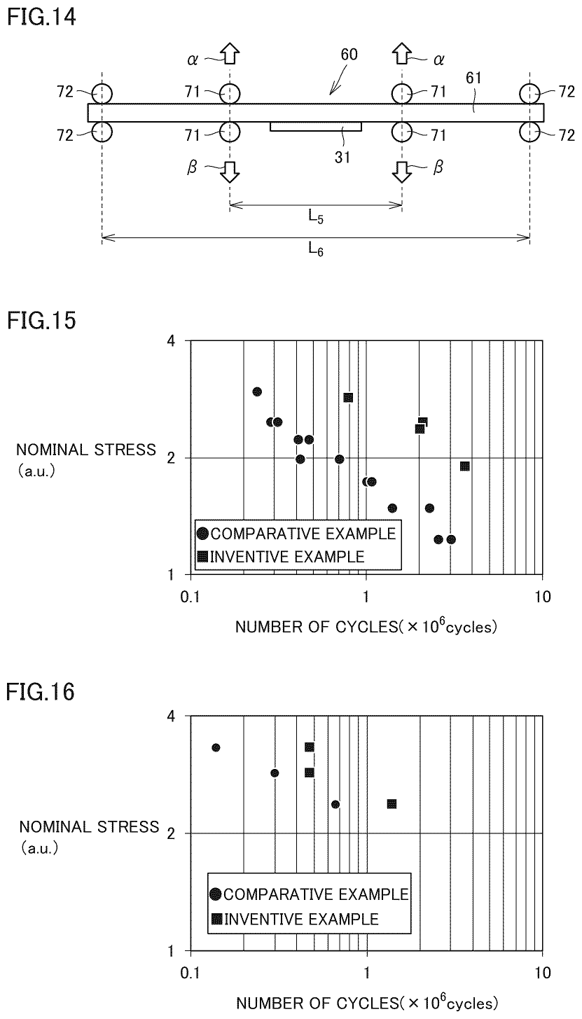

Next, a four-point bending fatigue test was conducted using the test specimens 60 of FIGS. 8 to 10 and the test specimens 60 of FIG. 11. FIG. 14 is a schematic diagram illustrating the method of conducting the fatigue test. Referring to FIG. 14, in the fatigue test, flexural loads were repeatedly applied in the state where a test specimen 60 was clamped in the thickness direction using inner pins 71 and outer pins 72. The outer pins 72 were arranged at both ends in the longitudinal direction of the test specimen 60 to secure the test specimen 60. The inner pins 71 were arranged to sandwich a region where the backing material 31 is disposed, and were displaced along the arrows a and B to apply flexural loads to the test specimen 60. A distance L₅ between the inner pins 71 in the longitudinal direction of the test specimen 60 was 150 mm, and a distance L₆ between the outer pins 72 was 350 mm. The test was conducted under reversed loading, with a stress ratio R of −1 and a cyclic load frequency of 8 Hz. The number of load cycles to failure of the test specimen 60 at each stress was investigated. The test results are shown in FIGS. 15 and 16.

FIG. 15 is a diagram (S-N curve) showing the fatigue test results for the test specimens of FIGS. 8 to 10. FIG. 16 is a diagram (S-N curve) showing the fatigue test results for the test specimens of FIG. 11. In FIGS. 15 and 16, the horizontal axis corresponds to the number of load cycles. The vertical axis corresponds to the nominal stress applied, with values shown in arbitrary units. In FIGS. 15 and 16, the data points for Inventive Examples are shown as square data points, and the data points for Comparative Examples are shown as circular data points. It should be noted that in the four-point bending fatigue test using the test specimens of FIGS. 8 to 10, the fractures of the test specimens 60 all originated in the vicinity of the root. In the four-point bending fatigue test using the test specimens of FIG. 11, the fractures of the test specimens 60 all originated in the vicinity of the toes of the second welded portion 22 and the third welded portion 23.

Referring to FIG. 15, the fatigue strength of the test specimens of Inventive Examples clearly exceeds the fatigue strength of the test specimens of Comparative Examples. With the same amount of stress applied, Inventive Examples have approximately six times the life of Comparative Examples. This is considered to be attributable to the fact that the residual stress is in a state of compression, or in a relaxed state of tension, in the vicinity of the root from which fracture would originate. Further, referring to FIG. 16, the fatigue strength of the test specimens of Inventive Examples also clearly exceeds the fatigue strength of the test specimens of Comparative Examples even when the second welded portion 22 and the third welded portion 23 are formed. This is considered to be attributable to the fact that the residual stress in the state of tension is relaxed in the vicinity of the toes of the second welded portion 22 and the third welded portion 23 from which fracture would originate. The above experimental results confirm that the welded structure of the present disclosure is capable of providing a welded structure with improved fatigue strength.

While the case where a portion of the backing material is a transformed region has been described in the embodiments and examples above, the entire backing material may be a transformed region. Further, while a hydraulic excavator has been illustrated as an example of the work vehicle in the above embodiments, the work vehicle of the present disclosure is applicable to various work vehicles such as an electric excavator, a dump truck, a motor grader, a wheel loader, and the like. Furthermore, while the case where the welded structure of the present disclosure is included in a work implement of the hydraulic excavator has been described, the welded structure is widely applicable to a work implement of an excavator, a frame of a dump truck, a frame of a motor grader, a frame or work implement of a wheel loader, and the like.

It should be understood that the embodiments and examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: travel unit; 1A: track; 3: revolving unit; 4: work implement; 5: boom; 6: arm; 7: bucket; 8: cab; 11: upper plate; 11A: inner surface; 11B: outer surface; 11C: end surface; 12: left side plate; 12A: end surface; 12B: inner surface; 12C: outer surface; 13: right side plate; 14: lower plate; 15: boom foot bracket; 16: arm mounting bracket; 17: boom cylinder mounting portion; 18: arm cylinder mounting portion; 19: box-shaped structural body; 21: first welded portion; 21A: outer surface; 21B: second side surface; 21C: first side surface; 21D: bottom surface; 21E: root; 22: second welded portion; 22A: outer surface; 22B: first side surface; 22C: second side surface; 22D: toe; 23: third welded portion; 23A: outer surface; 23B: first side surface; 23C: second side surface; 23D: toe; 25: welded portion; 31: backing material; 31A: first surface; 31B: second surface; 31C: third surface; 31D: fourth surface; 31F: transformed region; 31G: transformed region; 31H: transformed region; 41: first member; 41A: end surface; 41B: second surface; 41C: first surface; 42: second member; 42C: first surface; 60: test specimen; 61: body portion; 61A: first main surface; 61B: second main surface; 61E: through hole; 71: inner pin; 72: outer pin; 100: hydraulic excavator; and 101: welded structure.

1. A welded structure comprising:
a first member which is a steel plate or a cast steel;
a second member which is a steel plate or a cast steel disposed adjacent to the first member with a space therebetween;
a first welded portion filling the space and joining the first member to the second member; and
a backing material composed of a steel and disposed in contact with the first welded portion so as to close a first opening of the space, the backing material including a transformed region having a martensitic structure in the region in contact with the first welded portion;
the steel constituting the backing material having a volume per unit mass greater at room temperature than at the Mₛ point.

2. The welded structure according to claim 1, further comprising a second welded portion disposed in contact with the first member and the backing material and joining the first member to the backing material.

3. The welded structure according to claim 1, further comprising a third welded portion disposed in contact with the second member and the backing material and joining the second member to the backing material.

4. The welded structure according to claim 1, wherein the first member and the second member are steel plates or cast steels having a thickness of not less than 6 mm.

5. The welded structure according to claim 1, wherein the steel constituting the backing material has a yield stress greater than a yield stress of a material constituting the first welded portion.

6. A work vehicle comprising the welded structure according to claim 1.

7. The work vehicle according to claim 6, wherein the welded structure is included in a work implement of the work vehicle.

8. The work vehicle according to claim 6, wherein the work vehicle is an excavator.
